(19) United States
(12) Patent Application Publication
(10) Pub. No.: US 2011/0128943 A1
(43) Pub. Date: Jun. 2, 2011

(54) WiFi and WiMAX Internetworking

(76) Inventor: Chang Hong Shan, Songjiang (CN)

(21) Appl. No.: 12/629,097

(22) Filed: Dec. 2, 2009

(51) Int. Cl. H04W 12/06; H04W 12/04; H04W 88/06; H04L 29/06

(52) U.S. Cl. 370/338; 455/411; 726/3; 455/552.1

(57) ABSTRACT

In accordance with some embodiments, a network may enable WiFi and WiMAX internetworking, such that a mobile node may move between the networks. This may be facilitated by assigning the same home agent and home address to a mobile node in both networks during authentication. In one embodiment, the assignment may be done by a server, such as an authentication, authorization, accounting server. A wireless gateway may control access by mobile nodes to the Internet. For example, the wireless gateway may intercept messages from a mobile node that wishes to access an Internet site and the wireless gateway can check whether the node is authorized to access the Internet.

### BACKGROUND

This relates to networks that use both WiMAX and WiFi communications.

In some networks, a base station may communicate via worldwide interoperability for microwave access (WiMAX) (IEEE Std. 802.16-2004, IEEE Standard for Local and Metropolitan Area Networks, Part 16: Interface for Fixed Broadband Wireless Access Systems, IEEE New York, N.Y. 10016) with an access point, which, in turn, communicates with other devices via WiFi (IEEE Std. 802.11 (1999-07-015) Wireless LAN Medium Access Control (MAC) and Physical Layer Specifications).

The integration of a WiFi access network in an existing WiMAX network infrastructure is called WiMAX-WiFi internetworking.

### BRIEF DESCRIPTION OF THE DRAWINGS

FIG. 1 is an architecture depiction of one embodiment of the present invention;

FIG. 2 is a flow chart for the network entry procedure in accordance with one embodiment;

FIG. 3 is a flow chart for a normal user offline procedure in accordance with one embodiment;

FIG. 4 is a flow chart for an abnormal user offline procedure in accordance with one embodiment;

FIG. 5 is a flow chart for fast roaming from WiMAX to WiFi in accordance with one embodiment; and

FIG. 6 is a flow chart for fast roaming from WiFi to WiMAX in accordance with one embodiment.

### DETAILED DESCRIPTION

A loosely coupled WiMAX/WiFi internetworking system enables a WiFi user to use common connection service network (CSN) elements of both WiMAX and WiFI. Examples of such elements include authentication, authorization, accounting (AAA), home agent (HA), Dynamic Host Configuration Protocol (DHCP) servers. In order to maintain the same Internet Protocol address for a terminal, the Internet Protocol address assigner, such as the DHCP server, AAA server or HA, may be the same, as the terminal moves between WiMAX and WiFi systems.

In accordance with some embodiments, a common billing and customer care support may be provided for both the WiMAX and WiFi systems. The WiMAX system may be the basis for access control and charging, as one example. Access to WiMAX CSN based services may be provided, as is session continuity in some embodiments.

As used herein, a WiFi gateway is a device provided behind access points (APs) to help the access point and backhaul servers communicate with each other. The WiFi gateway implements proxy mobile Internet Protocol (PMIP) client (e.g. PMIPv4 or Mip4-proxy-mode, PMIP4 client, See K. Leung et al. WiMAX Forum/3GPP2 Proxy Mobile IPv4, Internet Engineering Task Force (IETF), February 2008) and foreign agent (FA) functionality, as well as PMIP key generation functions, in some embodiments.

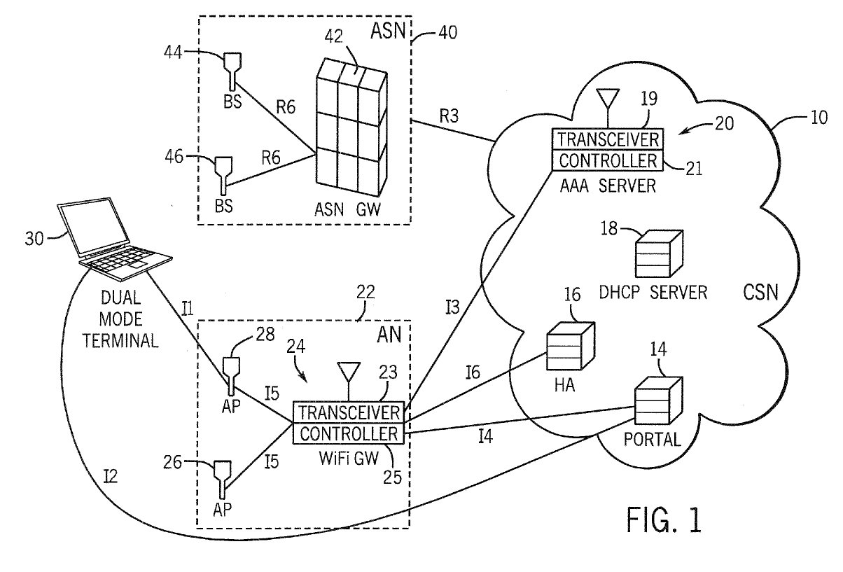

Thus, referring to FIG. 1, an internetworking architecture may include a CSN 10 that includes a portal 14, an HA 16, a DHCP server 18, and an AAA server 20. The AAA server 20 includes a WiMAX wireless transceiver 19 and a controller 21 that controls its operation.

An access network 22 may include the WiFi gateway (WI-GW) 24. The WiFi gateway 24 communicates with access points (APs) 26 and 28 (via connections I5 and I6), as well as with the AAA server 20 (via connection I3), the HA 16 (via connection I6), and the portal 14 (via connection I4). The WiFi gateway 24 includes a wireless transceiver 23 that operates in both WiMAX and WiFi modes and a controller 25. The controller 25 controls the operation of the gateway 24.

A dual-mode terminal 30, that works in both WiMAX and WiFi systems, communicates with the portal 14 (via connection I2) and the access point 28 (via connection I1). The terminal may be any wireless device, including a laptop computer, a cell phone, a personal digital assistant, or a mobile Internet device (MID), as examples. An access service network 40 includes an access service network gateway 42 and base stations 44 and 46. The access service network gateway 42 communicates with the base stations 44 and 46 (via connections R6), as well as with the CSN 10 (via connection R3). The WiFi gateway 24 includes the functionality of a Broad Access Server (BAS), a PMIP4 client, and FA towards the CSN, in one embodiment. The WiFi gateway may also generate mobile Internet Protocol (MIP) keys for PMIP registration and revocation.

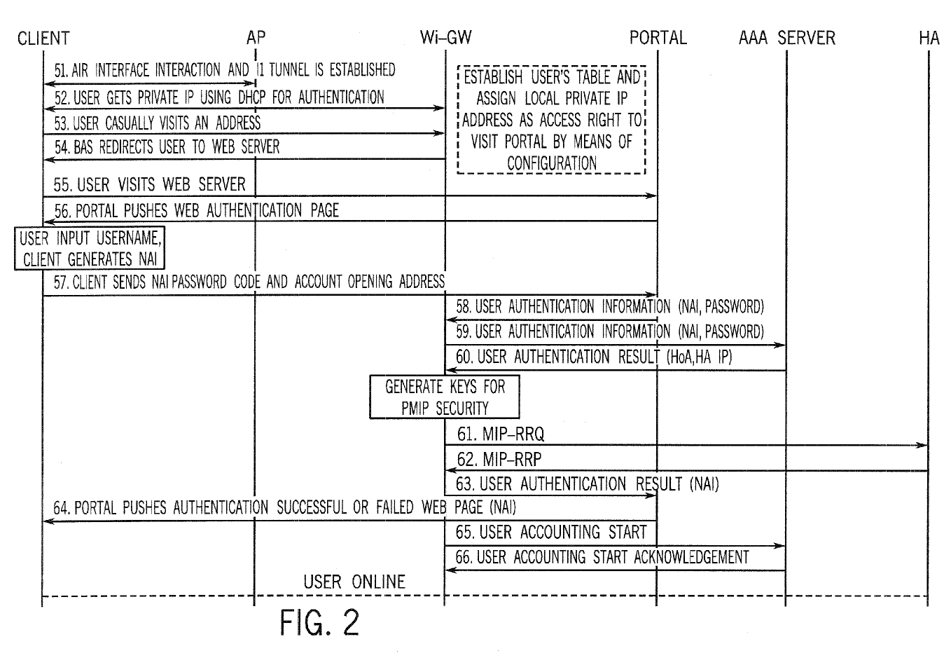

Referring to FIG. 2, a network entry protocol for a terminal, such as the dual mode terminal 30, begins at 51 when the terminal or client executes an interaction with an access point 28 at the air interface to establish a connection or tunnel. The interaction may include a probe request and probe response (Req/Rsp), association request and response (Req/Rsp), as two examples. Then, at 52, the client gets the Internet Protocol address for the local area usage using DHCP, for example.

After getting a private Internet Protocol address, the user of the terminal 30 can casually visit an address, as indicated at 53. The WiFi gateway establishes a user's table and assigns a local private Internet Protocol address as an access right to visit the portal by means of configuration.

A request to visit a site is sent to an access point and the WiFi gateway. The WiFi gateway can intercept this message and check whether the client is allowed to visit the Internet or not. At 54, if the client has no access right, the WiFi gateway, through its BAS, redirects the request to the portal or web server. At 55, the client visits the portal.

Upon receiving the client's request, the portal pushes a web authentication page to the client at 56. The user inputs a user name and password information. According to the user name, the client generates a network access identifier (NAI). Then, at 57, the client sends the NAI, password, code, and account opening address to the portal. At 58, the portal forwards the user authentication information (NAI, password) to the WiFi gateway. The WiFi gateway sends an access-request at 59 with the NAI and password to the AAA server via Remote Authentication Dial in User Service (RADIUS) in one embodiment. See Network Working Group, IETF RADIUS Design Guidelines, Oct. 12, 2009. At 60, the AAA server checks if the NAI/password is valid. If it is valid, the AAA server sends an access accept to the WiFi gateway. A home address (HoA), HA, and Internet Protocol address are included. At the same time, the AAA server generates a Mobile Internet Protocol Root Key (MIP-RK) and related PMIP4 keys (Mobile node (MN)-HA-PMIP4, FA-RK, HA-RK) and sends them to the WiFi gateway).

At 61, the WiFi gateway sends the Mobile IP Registration Request (MIP-RRQ) to the HA, using the HoA and HA assigned by the AAA server and the PMIP4 key is generated by the AAA server and WiFi gateway. After receiving the MIP-RRQ, the HA checks with the AAA server. If valid, the HA replies with a successful Mobile IP Registration Response MIP-RRP at 62. At 63, the WiFi gateway sends an authentication result to the portal. At 64, the portal pushes the authentication success or failure page to the client. At 65 and 66, accounting starts between the WiFi gateway and the AAA server. Then the user is “online.”

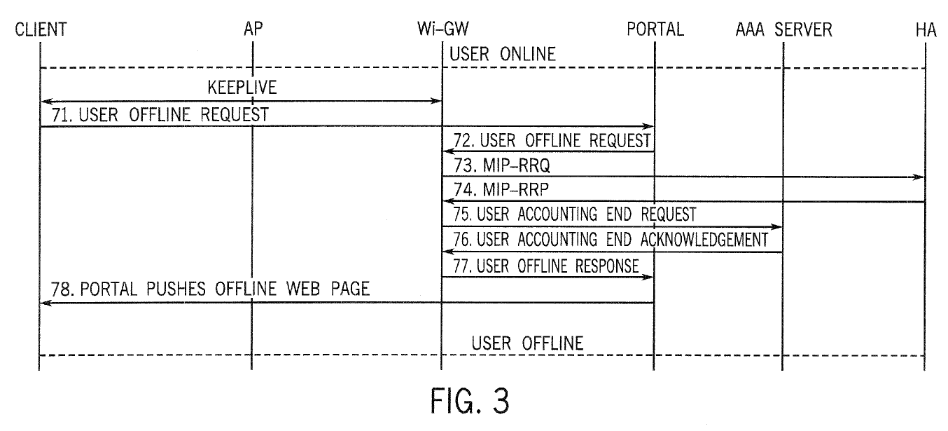

Referring to FIG. 3, showing a normal user offline procedure in accordance with one embodiment, if the user wants to be offline, the user sends a user offline request to the portal at 71. Then, at 72, the portal forwards the user offline request to the WiFi gateway. At 73, the WiFi gateway sends the MIP-RRQ with a lifetime equal to zero to the HA.

At 74, after checking with the AAA server, the HA replies with an MIP-RRP. At 75 and 76, the accounting ending procedure is implemented. Then at 77, the WiFi gateway sends the user offline response to the portal. At 78, the portal pushes the offline webpage to the client. Then the user is offline.

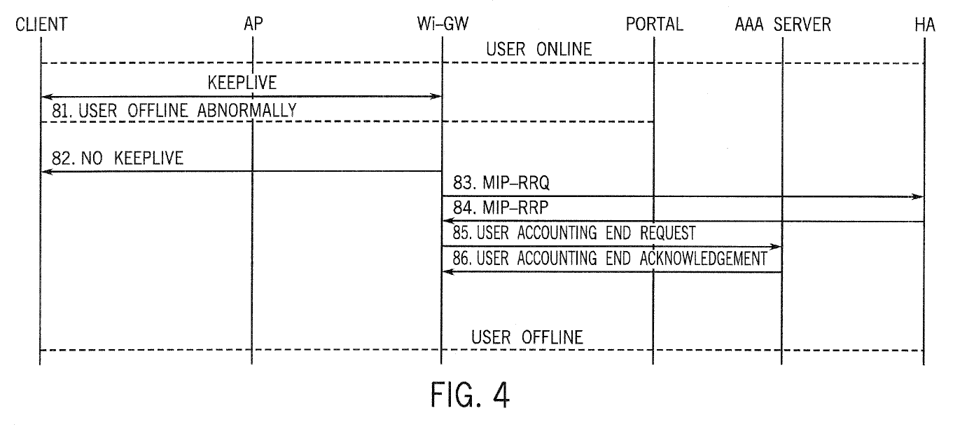

Referring next to FIG. 4, the abnormal user offline procedure is illustrated in accordance with one embodiment. At 81, the user is offline abnormally. At 82, the WiFi gateway finds out that the client is not alive. At 83, the wireless gateway sends an MIP-RRQ with a lifetime equal to zero to the HA.

After checking with the AAA server, the HA replies with an MIP-RRP to the WiFi gateway at 84. At 85 and 86, the accounting ending procedure is implemented and then the user is offline.

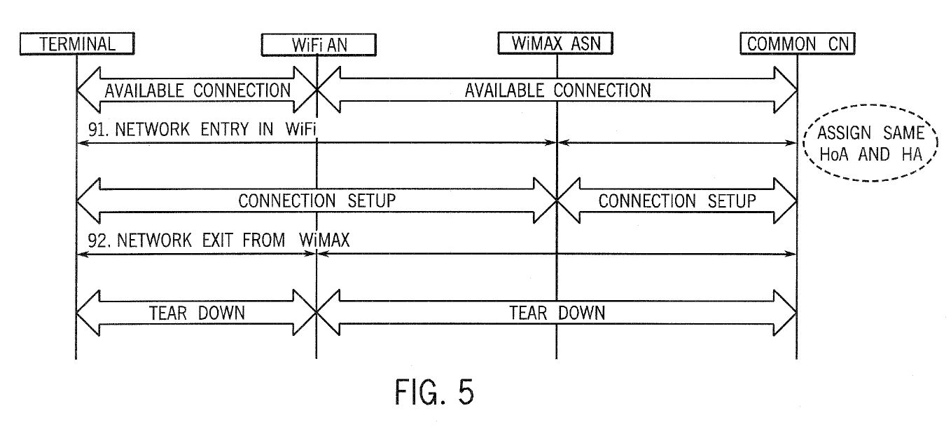

Referring to FIG. 5, a procedure for fast roaming from WiMAX to WiFi is illustrated. Before a terminal does fast roaming from WiMAX to WiFi, a connection is available among the terminal, the WiMAX ASN, and the common core network (ON). At 91, the terminal performs network entry in the WiFi system. The same HoA and HA are assigned in both WiMAX and WiFi. After this step, the connections among the terminal, the WiFi access network, and the common CN are set up. The terminal then performs network exit (92) from the WiMAX system. After this step, the former available connections among the terminal, WiMAX ASN, and Common CN are torn down.

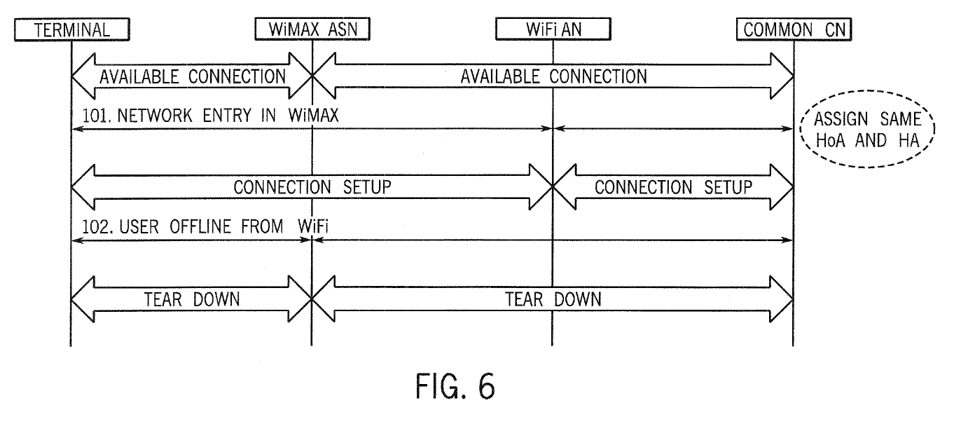

Referring to FIG. 6, fast roaming is possible from WiFi to WiMAX systems. Before the terminal does fast roaming from WiFi to WiMAX, a connection is available among the terminal, the WiFi access network, and the Common CN. At 101, the terminal performs network entry in WiMAX. The same HoA and HA are assigned in both WiMAX and WiFi. After this step, the connections among the terminal, WiMAX ASC, and common CN are set up. Then at 102, the terminal performs a user offline procedure from WiFi. After this step, the former available connections among the terminal, WiFi access network, and common CN are torn down.

In some embodiments, WiFi and WiMAX internetworking is facilitated because an operator who owns a WiFi or WiMAX network can easily integrate other technologies. In order to smooth mobility between WiFi and WiMAX systems, the wireless gateway integrates PMIP4, MN, FA, and MIP key generation functions. In order to assure that the HoA and HA are not changed during system switching, the AAA server assigns the same HoA and HA to PMIP4 MN during the authentication procedure. Call flows between the wireless gateway and the HA during the network entry and user offline procedures facilitate interoperability, as does the protocol stack between the wireless gateway and the HA.

The sequences shown in FIGS. 2-6 may be implemented in hardware, software, or firmware. In software embodiments, the sequence may be implemented by instructions stored in a suitable computer readable medium, such as the controller 21, in the case of the AAA server 20, or the controller 25, in the case of the wireless gateway 24. The instructions may be executed by a processor or controller, such the controller 21, in the case of the AAA server 21, or the controller 25, in the case of the WiFi gateway. In other embodiments, a separate processor and computer readable medium may be used.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
operating overlapping WiMAX and WiFi access networks; and
assigning the same home agent and home address to a mobile node in both networks during authentication.

2. The method of claim 1 including using a wireless gateway with key generation functions.

3. The method of claim 1 including using a wireless gateway that implements a proxy mobile Internet Protocol client.

4. The method of claim 2 including using a wireless gateway that implements foreign agent functionality.

5. The method of claim 1 including using a wireless gateway that implements mobile Internet Protocol key generation.

6. The method of claim 2 including using said wireless gateway to intercept a message from a mobile node that wishes to visit an Internet website and checking whether the node is authorized to access the Internet.

7. The method of claim 1 including receiving a user offline request from a portal and sending a mobile Internet Protocol request with a lifespan equal to zero to the home address from said wireless gateway.

8. A computer readable medium storing instructions executed by a computer to:
assign the same home agent and home address to a mobile node in both a WiMAX and a WiFi access network; and
use the same home agent and home address when said mobile node moves between said networks.

9. The medium of claim 8 further storing instructions to implement a proxy mobile Internet Protocol client with key generation functions.

10. The medium of claim 8 further storing instructions to implement a foreign agent functionality for key generation.

11. The medium of claim 8 further storing instructions to implement a mobile Internet Protocol key generation.

12. The medium of claim 8 further storing instructions to intercept a message from a mobile node that wishes to access an Internet site and checking whether the node is authorized to access the Internet.

13. The medium of claim 8 further storing instructions to receive a user offline request from a portal and send a mobile Internet Protocol request with a lifetime equal to zero to the home address of said node.

14. An apparatus comprising:
a transceiver operable in both WiMAX and WiFi networks; and
a controller coupled to said transceiver, said controller to intercept a message from a mobile node that wishes to access an Internet website, and said controller to check whether the node is authorized to access the Internet.

15. The apparatus of claim 14 wherein said apparatus is a wireless gateway operating in both the WiMAX and WiFi networks.

16. The apparatus of claim 14 wherein said apparatus includes key generation functions.

17. The apparatus of claim 16 wherein said key generation functions includes a wireless mobile Internet Protocol client, a foreign agent client, or a mobile Internet Protocol key generation function.

18. The apparatus of claim 14, said controller to assign the same home agent and home address to a mobile node in both a WiMAX and a WiFi access network.

19. The apparatus of claim 18 wherein said apparatus is one of an authentication, authorization, accounting server, a home agent, or a dynamic host configuration protocol server.

20. The apparatus of claim 18 to receive a user accounting end request and to provide an acknowledgement in response thereto to enable a user to go offline.
